(19) United States
(12) Patent Application Publication
(10) Pub. No.: US 2025/0238802 A1
(43) Pub. Date: Jul. 24, 2025

(54) SYSTEMS AND METHODS FOR MONITORING FRAUD ASSOCIATED WITH TEMPORARY PAYMENT CARDS

(71) Applicant: Capital One Services, LLC, McLean, VA (US)

(72) Inventors: Joshua Edwards, Philadelphia, PA (US); Michael Mossoba, Arlington, VA (US); Tyler Maiman, Melville, NY (US)

(21) Appl. No.: 18/418,620

(22) Filed: Jan. 22, 2024

(51) Int. Cl. G06Q 20/40; G06Q 20/34

(52) U.S. Cl. CPC G06Q 20/4016; G06Q 20/34

(57) ABSTRACT

Disclosed embodiments may include a system for monitoring fraud. The system may receive, via an automated teller machine (ATM), personally identifiable information associated with a user, may authenticate the user, and may generate a temporary account number. The system may dispense, via the ATM, a payment card associated with the temporary account number. The system may receive, via a merchant point of sale (POS) terminal, an attempted transaction associated with the payment card. The system may determine, using machine learning models (MLMs), a likelihood of fraud associated with the attempted transaction, wherein the MLMs are trained based on attempted transaction(s) associated with an identified plurality of previously generated payment cards each associated with a respective temporary account number generated responsive to authenticating a respective associated user. The system may determine whether the likelihood of fraud exceeds a threshold, and responsive to such determination, may approve the attempted transaction.

### FIELD

The disclosed technology relates to systems and methods for monitoring fraud associated with temporary payment cards. Specifically, this disclosed technology relates to determining a likelihood of fraud associated with a transaction based on transactions similarly associated with pre-authenticated temporary payment cards.

### BACKGROUND

Traditional systems and methods for fraud monitoring typically utilize models that incorporate infinite amounts of data, such as transaction data, account data, card data, etc., to determine a likelihood of fraud associated with each incoming attempted transaction. These models are typically trained on datasets including different types of transactions and payment methods such that the models may be familiar with most any type of attempted transaction to be able to identify an associated respective likelihood of fraud.

Accordingly, there is a need for improved systems and methods for fraud monitoring associated with temporary payment cards. Embodiments of the present disclosure may be directed to this and other considerations.

### SUMMARY

Disclosed embodiments may include a system for fraud monitoring. The system may include one or more processors, and a memory in communication with the one or more processors and storing instructions that, when executed by the one or more processors, are configured to cause the system to conduct fraud monitoring associated with temporary payment cards. The system may receive, via an automated teller machine (ATM), personally identifiable information associated with a first user. Responsive to receiving the personally identifiable information, the system may authenticate the first user. Responsive to authenticating the first user, the system may generate a temporary account number. The system may associate the temporary account number with a primary account associated with the first user. The system may dispense, via the ATM, a physical payment card associated with the temporary account number. The system may receive, via a merchant point of sale (POS) terminal, an attempted transaction associated with the physical payment card. The system may identify a plurality of previously generated physical payment cards each associated with a respective temporary account number generated responsive to authenticating a respective associated user. The system may determine, using one or more machine learning models (MLMs), a likelihood of fraud associated with the attempted transaction, wherein the one or more MLMs are trained based on one or more attempted transactions associated with the identified plurality of previously generated physical payment cards. The system may determine whether the likelihood of fraud exceeds a threshold. Responsive to determining the likelihood of fraud does not exceed the threshold, the system may approve the attempted transaction.

Disclosed embodiments may include a system for fraud monitoring. The system may include one or more processors, and a memory in communication with the one or more processors and storing instructions that, when executed by the one or more processors, are configured to cause the system to conduct fraud monitoring associated with temporary payment cards. The system may receive, via one or more ATMs, respective personally identifiable information associated with a plurality of users. Responsive to receiving the respective personally identifiable information, the system may authenticate the plurality of users. Responsive to authenticating the plurality of users, the system may generate a respective temporary account number associated with each of the plurality of users. The system may associate the respective temporary account number with a respective primary account associated with each of the plurality of users. The system may dispense, via the one or more ATMs, a respective physical payment card associated with each of the respective temporary account numbers. The system may receive, via a merchant POS terminal, an attempted transaction associated with a first physical payment card. The system may determine, using one or more MLMs, a likelihood of fraud associated with the attempted transaction, wherein the one or more MLMs are trained based on one or more attempted transactions associated with the respective physical payment card associated with each of the respective temporary account numbers. The system may determine whether the likelihood of fraud exceeds a threshold. Responsive to determining the likelihood of fraud does not exceed the threshold, the system may approve the attempted transaction.

Disclosed embodiments may include a system for fraud monitoring. The system may include one or more processors, and a memory in communication with the one or more processors and storing instructions that, when executed by the one or more processors, are configured to cause the system to conduct fraud monitoring associated with temporary payment cards. The system may receive, via one or more ATMs, personally identifiable information associated with a plurality of users. The system may authenticate the plurality of users based on the personally identifiable information. The system may generate a respective temporary account number associated with each of the plurality of users. The system may dispense, via the one or more ATMs, a respective payment card associated with each of the respective temporary account numbers. The system may receive, via a merchant POS terminal, an attempted transaction associated with a first payment card. The system may determine, using one or more MLMs, a likelihood of fraud associated with the attempted transaction, wherein the one or more MLMs are trained based on one or more attempted transactions associated with the respective payment card associated with each of the respective temporary account numbers. The system may determine whether the likelihood of fraud exceeds a threshold. Responsive to determining the likelihood of fraud does not exceed the threshold, the system may approve the attempted transaction.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a flow diagram illustrating an exemplary method for monitoring fraud associated with temporary payment cards, in accordance with certain embodiments of the disclosed technology.

FIG. 2 is a flow diagram illustrating an exemplary method for monitoring fraud associated with temporary payment cards, in accordance with certain embodiments of the disclosed technology.

FIG. 3 is a block diagram of an example fraud monitoring system used to monitor fraud associated with temporary payment cards, according to an example implementation of the disclosed technology.

FIG. 4 is a block diagram of an example system that may be used to monitor fraud associated with temporary payment cards, according to an example implementation of the disclosed technology.

### DETAILED DESCRIPTION

Traditional systems and methods for fraud monitoring typically utilize models that incorporate infinite amounts of data, such as transaction data, account data, card data, etc., to determine a likelihood of fraud associated with each incoming attempted transaction. These models are typically trained on datasets including different types of transactions and payment methods such that the models may be familiar with most any type of attempted transaction to be able to identify an associated respective likelihood of fraud. These types of traditional models may present challenges, however, in providing increased accuracy in their predictions when it comes to evaluating only specific types of transactions.

Accordingly, examples of the present disclosure may provide for dispensing a temporary payment card from an ATM responsive to authenticating a user based on receiving the user's personally identifiable information, receiving an attempted transaction associated with the temporary payment card via a merchant POS terminal, identifying a plurality of previously generated temporary payment cards each similarly generated responsive to authenticating a respective associated user, and using one or more MLMs to determine a likelihood of fraud associated with the attempted transaction. The one or more MLMs may be trained based on attempted transactions associated with the identified plurality of previously generated temporary payment cards.

Disclosed embodiments may employ MLMs, among other computerized techniques, to aid in determining a likelihood of fraud associated with an attempted transaction based on other transactions similarly associated with pre-authenticated temporary payment cards. Machine learning models are a unique computer technology that involves training models to complete tasks and make decisions. These techniques may help to improve database and network operations. For example, the systems and methods described herein may utilize, in some instances, MLMs, which are necessarily rooted in computers and technology, to determine whether a specific transaction may be associated with fraud based on a subset of finely tuned similar transaction data. This, in some examples, may involve using specific input data and an MLM, applied to determine a likelihood of fraud associated with an attempted transaction. Using an MLM and a computer system configured in this way may allow the system to provide finely tuned fraud monitoring based only on specific types of transaction data.

This may provide an advantage and improvement over prior technologies that may not be configured to utilize models that are finely tuned or trained on a subset of specific data. The present disclosure solves this problem by identifying attempted transactions associated with previously generated and similarly authenticated temporary payment cards, and training models to evaluate a likelihood of fraud associated with a current attempted transaction based on that identified set of transactions. Furthermore, examples of the present disclosure may also improve the speed with which computers can monitor for fraud. Overall, the systems and methods disclosed have significant practical applications in the fraud monitoring field because of the noteworthy improvements of training fraud models based on finely tuned training data, which are important to solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

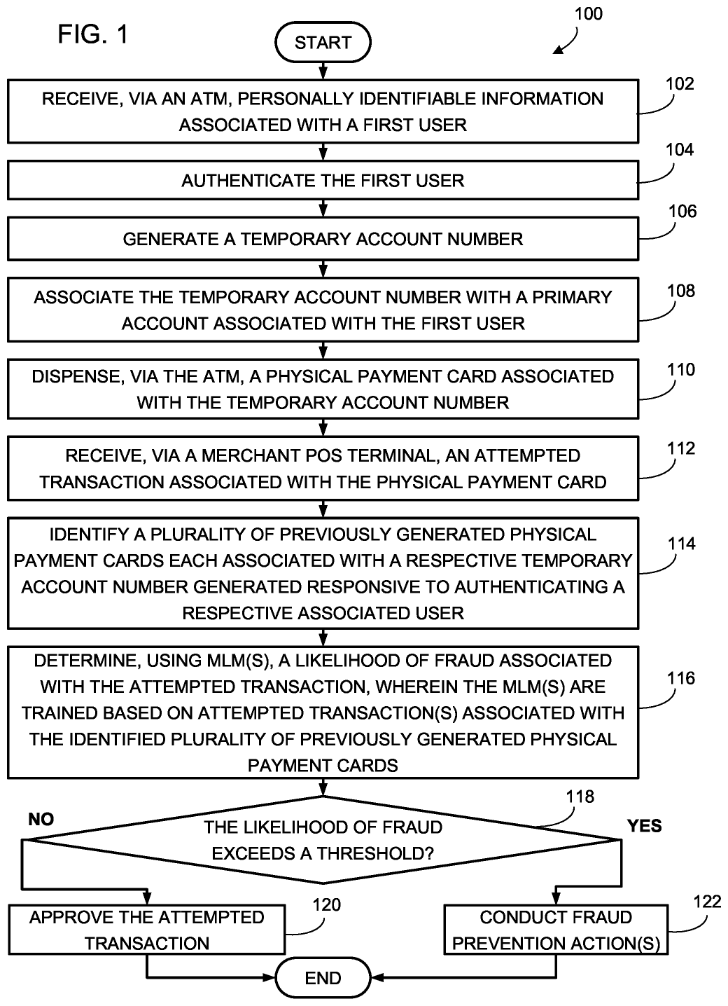

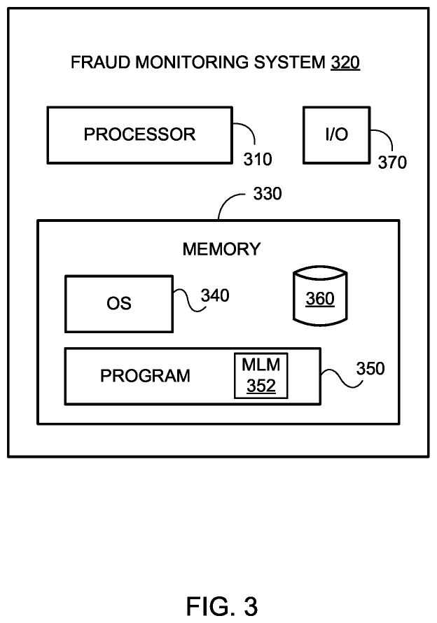

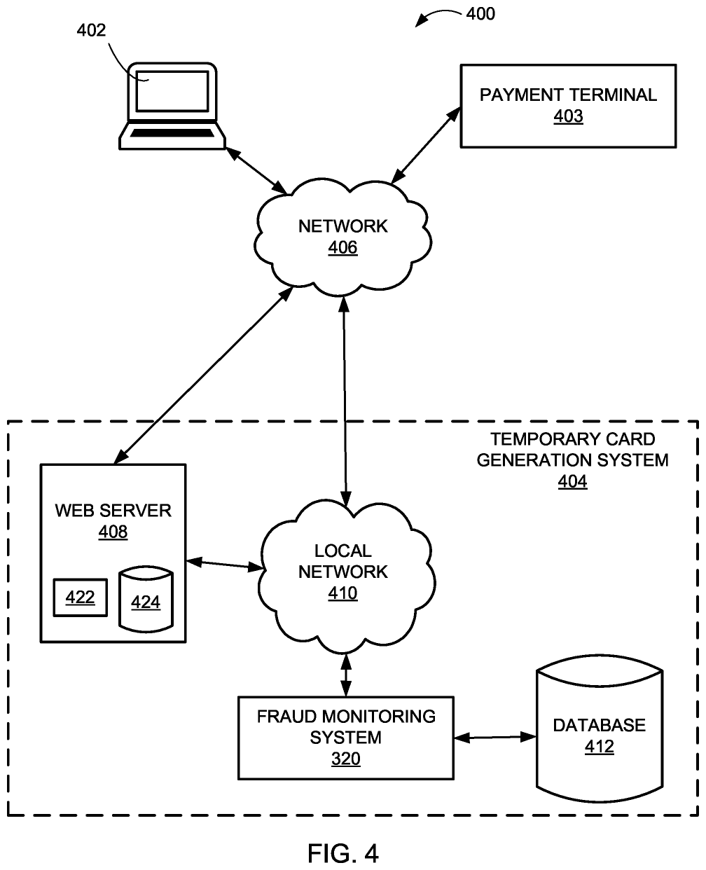

FIG. 1 is a flow diagram illustrating an exemplary method 100 for monitoring fraud associated with temporary payment cards, in accordance with certain embodiments of the disclosed technology. The steps of method 100 may be performed by one or more components of the system 400 (e.g., fraud monitoring system 320, web server 408 of temporary card generation system 404, and/or user device 402), as described in more detail with respect to FIGS. 3 and 4. It should be understood that certain embodiments of the disclosed technology may omit one or more blocks as being optional.

In block 102, the fraud monitoring system 320 may receive, via an ATM (e.g., user device 402), personally identifiable information associated with a first user. In some embodiments, the personally identifiable information may include, for example, a phone number, a social security number, an account number, etc. For example, a user or customer may enter the personally identifiable information via a display screen of the ATM.

In block 104, responsive to receiving the personally identifiable information, the fraud monitoring system 320 may authenticate the first user. In some embodiments, based on the received personally identifiable information, the system may only be able to authenticate the first user to a certain degree of confidence. For example, if the user does not have a mobile phone or ATM card that might provide a stronger form of authentication, but has another form of personally identifiable information (e.g., a phone number), the system may still be configured to authenticate the user based on such information.

In some embodiments, responsive to receiving the personally identifiable information, the system may be configured to transmit a request for the first user to provide additional authentication information. For example, the system may transmit a notification for display via the ATM to prompt the user to enter additional authentication information. In some embodiments, the additional authentication information may include, for example, biometric information or a biometric input (e.g., a fingerprint), an answer to a security question, a personal identification number (PIN), a code, etc.

In block 106, responsive to authenticating the first user, the fraud monitoring system 320 may generate a temporary account number. In some embodiments, the temporary account number may be a virtual card number. In some embodiments, generating the temporary account number may be further responsive to receiving the additional authentication information, as discussed above.

In block 108, the fraud monitoring system 320 may associate the temporary account number with a primary account associated with the first user. For example, the system may be configured to select (e.g., via user input or as a default setting) a primary account associated with the first user to financially back the temporary account number.

In block 110, the fraud monitoring system 320 may dispense, via the ATM, a physical payment card associated with the temporary account number. For example, the system may be configured to dispense a payment card associated with the temporary account number (e.g., with the temporary account number being printed on the physical payment card) rather than dispensing cash. A benefit of such feature is that the system may be able to track potential fraud associated with transactions involving the physical payment card, as further discussed below, that it would not otherwise be able to if the ATM instead dispensed cash to the first user.

In block 112, the fraud monitoring system 320 may receive, via a merchant POS terminal (e.g., payment terminal 403), an attempted transaction associated with the physical payment card. For example, the first user may attempt to purchase goods and/or services at a merchant location (e.g., a physical location, online location, etc.) using the physical payment card (e.g., by swiping the card at a POS terminal, entering the temporary account number into a POS terminal or other type of payment display, etc.).

In block 114, the fraud monitoring system 320 may identify a plurality of previously generated physical payment cards each associated with a respective temporary account number generated responsive to authenticating a respective associated user. For example, the system may identify other physical payment cards that were previously dispensed via ATMs after respective users were similarly authenticated (e.g., by entering respective personally identifiable information via the ATMs) and similarly associated with a respective temporary account number. In some embodiments, the system may be configured to identify such grouping of similarly generated payment cards by, for example, receiving payment and/or transaction information as users attempt to use such payment cards at various merchant payment terminals. A benefit of such identification step is that the system may utilize MLMs that are narrowly or finely tuned to identify potential transaction fraud based on other similar transaction and payment card types, as further discussed below.

In block 116, the fraud monitoring system 320 may determine, using one or more MLMs, a likelihood of fraud associated with the attempted transaction. In some embodiments, the one or more MLMs may be trained based on one or more attempted transactions associated with the identified plurality of previously generated physical payment cards, as discussed above. That is, rather than the MLMs be trained based on a variety of transaction and payment card types, the MLMs may be specially and narrowly trained based only on attempted transactions associated with similarly authenticated users and temporary payment cards dispensed to users based on such authentication, as discussed above with respect to the first user.

In some embodiments, the one or more MLMs may include a first MLM and a second MLM, where the first MLM is associated with a first weighting factor, and the second MLM is associated with a second weighting factor. The system may be configured to adjust the weights of each weighting factor in determining the likelihood of fraud associated with the attempted transaction. For example, the first MLM may be trained based on a variety of data associated with different transaction and payment card types (e.g., historical transaction data), while the second MLM may be trained based only on a narrow set of similarly authenticated attempted transactions (e.g., the identified plurality of previously generated physical payment cards), as discussed above. The system may determine the likelihood of fraud based on the first and second weighting factors where, for example, the second weighting factor is higher than the first weighting factor. A benefit of such feature is that it may provide for a more accurate determination of the likelihood of fraud by weighing more heavily the specially-trained MLM (e.g., the second MLM) over the generally-trained MLM (e.g., the first MLM).

In block 118, the fraud monitoring system 320 may determine whether the likelihood of fraud exceeds a threshold. In some embodiments, the threshold may be a static or predetermined threshold (e.g., a range or numerical value). In some embodiments, the threshold may be a dynamic threshold that may continuously change based on, for example, the number and/or types of MLMs being used in determining the likelihood of fraud, the weights and/or weighting factors associated with the utilized MLMs, etc. A benefit of such dynamic threshold is that respective determinations of likelihoods of fraud associated with attempted transactions may have a higher accuracy rate in terms of capturing potential transaction fraud.

In block 120, responsive to determining the likelihood of fraud does not exceed the threshold, the fraud monitoring system 320 may approve the attempted transaction. For example, when the first user attempts to use the physical payment card to conduct a purchase at a merchant payment terminal, an authorization request may be transmitted from the merchant system to an issuer system (e.g., owned and/or operated by a financial institution) that may authorize completion of the transaction.

In block 122, responsive to determining the likelihood of fraud exceeds the threshold, the fraud monitoring system 320 may conduct one or more fraud prevention actions. For example, the system may be configured to transmit a notification to a user device associated with the first user, transmit a notification for display via the merchant payment terminal, deny the transaction, or any other type of action that may help to reduce or avoid potential fraud.

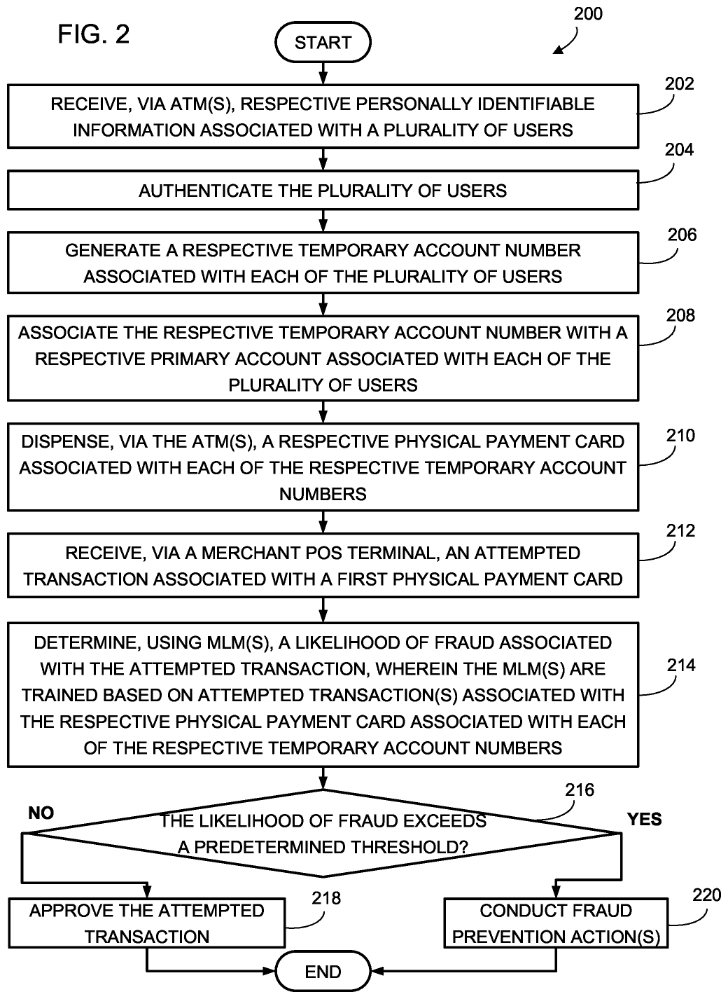

FIG. 2 is a flow diagram illustrating an exemplary method 200 for monitoring fraud associated with temporary payment cards, in accordance with certain embodiments of the disclosed technology. Method 200 of FIG. 2 is similar to method 100 of FIG. 1, except that method 200 is framed from the perspective of authenticating and generating respective temporary payment cards for a plurality of users rather than an individual user. The respective descriptions of blocks 216, 218, and 220 of method 200 are the same as or similar to those of blocks 118, 120, and 122 of method 100, and thus are not repeated herein for brevity. The steps of method 200 may be performed by one or more components of the system 400 (e.g., fraud monitoring system 320, web server 408 of temporary card generation system 404, and/or user device 402), as described in more detail with respect to FIGS. 3 and 4. It should be understood that certain embodiments of the disclosed technology may omit one or more blocks as being optional.

In block 202, the fraud monitoring system 320 may receive, via one or more ATMs (e.g., user device(s) 402), respective personally identifiable information associated with a plurality of users. This step may be similar to block 102 of method 100 except that the system may be configured to receive personally identifiable information associated with a plurality of users. For example, the system may be connected to a plurality of ATMs, any of which may be configured to receive personally identifiable information from a respective user.

In block 204, responsive to receiving the respective personally identifiable information, the fraud monitoring system 320 may authenticate the plurality of users. This step may be similar to block 104 of method 100 except that the system may be configured to respectively authenticate each user via the utilized ATM.

In block 206, responsive to authenticating the plurality of users, the fraud monitoring system 320 may generate a respective temporary account number associated with each of the plurality of users. This step may be similar to block 106 of method 100 except that the system may be configured to respectively generate a respective temporary account number for each of the plurality of users across the plurality of ATMs being utilized.

In block 208, the fraud monitoring system 320 may associate the respective temporary account number with a respective primary account associated with each of the plurality of users. This step may be similar to block 108 of method 100 except that it may apply to each of the plurality of users as opposed to only the first user.

In block 210, the fraud monitoring system 320 may dispense, via the one or more ATMs, a respective physical payment card associated with each of the respective temporary account numbers. This step may be similar to block 110 of method 100 except that it may apply to each of the plurality of users as opposed to only the first user.

In block 212, the fraud monitoring system 320 may receive, via a merchant point of sale (POS) terminal (e.g., payment terminal 403), an attempted transaction associated with a first physical payment card. This step may be similar to block 112 of method 100 except that the attempted transaction may be conducted by one of the plurality of users, or may be conducted by an individual user outside of the plurality of users.

In block 214, the fraud monitoring system 320 may determine, using one or more MLMs, a likelihood of fraud associated with the attempted transaction, wherein the one or more MLMs are trained based on one or more attempted transactions associated with the respective physical payment card associated with each of the respective temporary account numbers. This step may be similar to block 116 of method 100 except that the system may be configured to utilize MLMs trained based at least on each respective attempted transaction associated with the plurality of users.

FIG. 3 is a block diagram of an example fraud monitoring system 320 used to monitor fraud associated with temporary payment cards, according to an example implementation of the disclosed technology. According to some embodiments, the user device 402, payment terminal 403, and web server 408, as depicted in FIG. 4 and described below, may have a similar structure and components that are similar to those described with respect to fraud monitoring system 320 shown in FIG. 3. As shown, the fraud monitoring system 320 may include a processor 310, an input/output (I/O) device 370, a memory 330 containing an operating system (OS) 340 and a program 350. In some embodiments, program 350 may include an MLM 352 that may be trained, for example, to determine a likelihood of fraud associated with an attempted transaction based on a subset of other transactions conducted via similarly pre-authenticated temporary payment cards. In certain implementations, MLM 352 may issue commands in response to processing an event, in accordance with a model that may be continuously or intermittently updated. Moreover, processor 310 may execute one or more programs (such as via a rules-based platform or the trained MLM 352), that, when executed, perform functions related to disclosed embodiments.

In certain example implementations, the fraud monitoring system 320 may be a single server or may be configured as a distributed computer system including multiple servers or computers that interoperate to perform one or more of the processes and functionalities associated with the disclosed embodiments. In some embodiments fraud monitoring system 320 may be one or more servers from a serverless or scaling server system. In some embodiments, the fraud monitoring system 320 may further include a peripheral interface, a transceiver, a mobile network interface in communication with the processor 310, a bus configured to facilitate communication between the various components of the fraud monitoring system 320, and a power source configured to power one or more components of the fraud monitoring system 320.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, an NFC port, another like communication interface, or any combination thereof.

In some embodiments, a transceiver may be configured to communicate with compatible devices and ID tags when they are within a predetermined range. A transceiver may be compatible with one or more of: radio-frequency identification (RFID), NFC, Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 310 to communicate with other devices via wired or wireless networks, whether local or wide area, private or public, as known in the art. A power source may be configured to provide an appropriate alternating current (AC) or direct current (DC) to power components.

The processor 310 may include one or more of a microprocessor, microcontroller, digital signal processor, co-processor or the like or combinations thereof capable of executing stored instructions and operating upon stored data. The memory 330 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 330.

The processor 310 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 310 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 310 may be a single core processor that is configured with virtual processing technologies. In certain embodiments, the processor 310 may use logical processors to simultaneously execute and control multiple processes. The processor 310 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the fraud monitoring system 320 may include one or more storage devices configured to store information used by the processor 310 (or other components) to perform certain functions related to the disclosed embodiments. In one example, the fraud monitoring system 320 may include the memory 330 that includes instructions to enable the processor 310 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The fraud monitoring system 320 may include a memory 330 that includes instructions that, when executed by the processor 310, perform one or more processes consistent with the functionalities disclosed herein. Methods, systems, and articles of manufacture consistent with disclosed embodiments are not limited to separate programs or computers configured to perform dedicated tasks. For example, the fraud monitoring system 320 may include the memory 330 that may include one or more programs 250 to perform one or more functions of the disclosed embodiments. For example, in some embodiments, the fraud monitoring system 320 may additionally manage dialogue and/or other interactions with the customer via a program 350.

The processor 310 may execute one or more programs 250 located remotely from the fraud monitoring system 320. For example, the fraud monitoring system 320 may access one or more remote programs that, when executed, perform functions related to disclosed embodiments.

The memory 330 may include one or more memory devices that store data and instructions used to perform one or more features of the disclosed embodiments. The memory 330 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 330 may include software components that, when executed by the processor 310, perform one or more processes consistent with the disclosed embodiments. In some embodiments, the memory 330 may include a database 360 for storing related data to enable the fraud monitoring system 320 to perform one or more of the processes and functionalities associated with the disclosed embodiments.

The database 360 may include stored data relating to status data (e.g., average session duration data, location data, idle time between sessions, and/or average idle time between sessions) and historical status data. According to some embodiments, the functions provided by the database 360 may also be provided by a database that is external to the fraud monitoring system 320, such as the database 412 as shown in FIG. 4.

The fraud monitoring system 320 may also be communicatively connected to one or more memory devices (e.g., databases) locally or through a network. The remote memory devices may be configured to store information and may be accessed and/or managed by the fraud monitoring system 320. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The fraud monitoring system 320 may also include one or more I/O devices 370 that may comprise one or more interfaces for receiving signals or input from devices and providing signals or output to one or more devices that allow data to be received and/or transmitted by the fraud monitoring system 320. For example, the fraud monitoring system 320 may include interface components, which may provide interfaces to one or more input devices, such as one or more keyboards, mouse devices, touch screens, track pads, trackballs, scroll wheels, digital cameras, microphones, sensors, and the like, that enable the fraud monitoring system 320 to receive data from a user (such as, for example, via the user device 402).

In examples of the disclosed technology, the fraud monitoring system 320 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

The fraud monitoring system 320 may contain programs that train, implement, store, receive, retrieve, and/or transmit one or more MLMs. Machine learning models may include a neural network model, a large neural network, a large language model (LLM), a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The fraud monitoring system 320 may be configured to adjust model parameters during training. Model parameters may include weights, coefficients, offsets, or the like. Training may be supervised or unsupervised.

The fraud monitoring system 320 may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The fraud monitoring system 320 may be configured to optimize statistical models using known optimization techniques.

Furthermore, the fraud monitoring system 320 may include programs configured to retrieve, store, and/or analyze properties of data models and datasets. For example, fraud monitoring system 320 may include or be configured to implement one or more data-profiling models. A data-profiling model may include machine learning models and statistical models to determine the data schema and/or a statistical profile of a dataset (e.g., to profile a dataset), consistent with disclosed embodiments. A data-profiling model may include an RNN model, a CNN model, or other machine-learning model.

The fraud monitoring system 320 may include algorithms to determine a data type, key-value pairs, row-column data structure, statistical distributions of information such as keys or values, or other property of a data schema may be configured to return a statistical profile of a dataset (e.g., using a data-profiling model). The fraud monitoring system 320 may be configured to implement univariate and multivariate statistical methods. The fraud monitoring system 320 may include a regression model, a Bayesian model, a statistical model, a linear discriminant analysis model, or other classification model configured to determine one or more descriptive metrics of a dataset. For example, fraud monitoring system 320 may include algorithms to determine an average, a mean, a standard deviation, a quantile, a quartile, a probability distribution function, a range, a moment, a variance, a covariance, a covariance matrix, a dimension and/or dimensional relationship (e.g., as produced by dimensional analysis such as length, time, mass, etc.) or any other descriptive metric of a dataset.

The fraud monitoring system 320 may be configured to return a statistical profile of a dataset (e.g., using a data-profiling model or other model). A statistical profile may include a plurality of descriptive metrics. For example, the statistical profile may include an average, a mean, a standard deviation, a range, a moment, a variance, a covariance, a covariance matrix, a similarity metric, or any other statistical metric of the selected dataset. In some embodiments, fraud monitoring system 320 may be configured to generate a similarity metric representing a measure of similarity between data in a dataset. A similarity metric may be based on a correlation, covariance matrix, a variance, a frequency of overlapping values, or other measure of statistical similarity.

The fraud monitoring system 320 may be configured to generate a similarity metric based on data model output, including data model output representing a property of the data model. For example, fraud monitoring system 320 may be configured to generate a similarity metric based on activation function values, embedding layer structure and/or outputs, convolution results, entropy, loss functions, model training data, or other data model output). For example, a synthetic data model may produce first data model output based on a first dataset and a produce data model output based on a second dataset, and a similarity metric may be based on a measure of similarity between the first data model output and the second-data model output. In some embodiments, the similarity metric may be based on a correlation, a covariance, a mean, a regression result, or other similarity between a first data model output and a second data model output. Data model output may include any data model output as described herein or any other data model output (e.g., activation function values, entropy, loss functions, model training data, or other data model output). In some embodiments, the similarity metric may be based on data model output from a subset of model layers. For example, the similarity metric may be based on data model output from a model layer after model input layers or after model embedding layers. As another example, the similarity metric may be based on data model output from the last layer or layers of a model.

The fraud monitoring system 320 may be configured to classify a dataset. Classifying a dataset may include determining whether a dataset is related to another dataset. Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may indicate a similarity between datasets and/or a hierarchical relationship (e.g., a data lineage, a parent-child relationship). In some embodiments, classifying a dataset may include generating graphical data, such as anode diagram, a tree diagram, or a vector diagram of datasets. Classifying a dataset may include estimating a likelihood that a dataset relates to another dataset, the likelihood being based on the similarity metric.

The fraud monitoring system 320 may include one or more data classification models to classify datasets based on the data schema, statistical profile, and/or edges. A data classification model may include a convolutional neural network, a random forest model, a recurrent neural network model, a support vector machine model, or another machine learning model. A data classification model may be configured to classify data elements as actual data, synthetic data, related data, or any other data category. In some embodiments, fraud monitoring system 320 is configured to generate and/or train a classification model to classify a dataset, consistent with disclosed embodiments.

The fraud monitoring system 320 may also contain one or more prediction models. Prediction models may include statistical algorithms that are used to determine the probability of an outcome, given a set amount of input data. For example, prediction models may include regression models that estimate the relationships among input and output variables. Prediction models may also sort elements of a dataset using one or more classifiers to determine the probability of a specific outcome. Prediction models may be parametric, non-parametric, and/or semi-parametric models.

In some examples, prediction models may cluster points of data in functional groups such as “random forests.” Random Forests may comprise combinations of decision tree predictors. (Decision trees may comprise a data structure mapping observations about something, in the “branch” of the tree, to conclusions about that thing's target value, in the “leaves” of the tree.) Each tree may depend on the values of a random vector sampled independently and with the same distribution for all trees in the forest. Prediction models may also include artificial neural networks. Artificial neural networks may model input/output relationships of variables and parameters by generating a number of interconnected nodes which contain an activation function. The activation function of a node may define a resulting output of that node given an argument or a set of arguments. Artificial neural networks may generate patterns to the network via an ‘input layer’, which communicates to one or more “hidden layers” where the system determines regressions via a weighted connections. Prediction models may additionally or alternatively include classification and regression trees, or other types of models known to those skilled in the art. To generate prediction models, the asset detection system may analyze information applying machine-learning methods.

While the fraud monitoring system 320 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the fraud monitoring system 320 may include a greater or lesser number of components than those illustrated.

FIG. 4 is a block diagram of an example system that may be used to view and interact with temporary card generation system 404, according to an example implementation of the disclosed technology. The components and arrangements shown in FIG. 4 are not intended to limit the disclosed embodiments as the components used to implement the disclosed processes and features may vary. As shown, temporary card generation system 404 may interact with a user device 402 and/or a payment terminal 403 (e.g., a merchant point of sale (POS) device) via a network 406. In certain example implementations, the temporary card generation system 404 may include a local network 410, a fraud monitoring system 320, a web server 408, and a database 412.

In some embodiments, a respective user may operate the user device 402. The user device 402 can include one or more of a mobile device, smart phone, smart device (e.g., smart speaker), general purpose computer, tablet computer, laptop computer, telephone, public switched telephone network (PSTN) landline, automated teller machine (ATM), smart wearable device, voice command device, other mobile computing device, or any other device capable of communicating with the network 406 and ultimately communicating with one or more components of the temporary card generation system 404. In some embodiments, the user device 402 may include or incorporate electronic communication devices for hearing or vision impaired users.

Users may include individuals such as, for example, subscribers, clients, prospective clients, or customers of an entity associated with an organization, such as individuals who have obtained, will obtain, or may obtain a product, service, or consultation from or conduct a transaction in relation to an entity associated with the temporary card generation system 404. According to some embodiments, the user device 402 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The fraud monitoring system 320 may include programs (scripts, functions, algorithms) to configure data for visualizations and provide visualizations of datasets and data models on the user device 402. This may include programs to generate graphs and display graphs. The fraud monitoring system 320 may include programs to generate histograms, scatter plots, time series, or the like on the user device 402. The fraud monitoring system 320 may also be configured to display properties of data models and data model training results including, for example, architecture, loss functions, cross entropy, activation function values, embedding layer structure and/or outputs, convolution results, node outputs, or the like on the user device 402.

The network 406 may be of any suitable type, including individual connections via the internet such as cellular or WiFi networks. In some embodiments, the network 406 may connect terminals, services, and mobile devices using direct connections such as RFID, NFC, Bluetooth™ BLE, WiFi™, ZigBee™, ABC protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 406 may include any type of computer networking arrangement used to exchange data. For example, the network 406 may be the Internet, a private data network, virtual private network (VPN) using a public network, and/or other suitable connection(s) that enable(s) components in the system 400 environment to send and receive information between the components of the system 400. The network 406 may also include a PSTN and/or a wireless network.

The temporary card generation system 404 may be associated with and optionally controlled by one or more entities such as a business, corporation, individual, partnership, or any other entity that provides one or more of goods, services, and consultations to individuals such as customers. In some embodiments, the temporary card generation system 404 may be controlled by a third party on behalf of another business, corporation, individual, partnership. The temporary card generation system 404 may include one or more servers and computer systems for performing one or more functions associated with products and/or services that the organization provides.

Web server 408 may include a computer system configured to generate and provide one or more websites accessible to customers, as well as any other individuals involved in accessing temporary card generation system 404's normal operations. Web server 408 may include a computer system configured to receive communications from user device 402 via for example, a mobile application, a chat program, an instant messaging program, a voice-to-text program, an SMS message, email, or any other type or format of written or electronic communication. Web server 408 may have one or more processors 422 and one or more web server databases 424, which may be any suitable repository of website data. Information stored in web server 408 may be accessed (e.g., retrieved, updated, and added to) via local network 410 and/or network 406 by one or more devices or systems of system 400. In some embodiments, web server 408 may host websites or applications that may be accessed by the user device 402. For example, web server 408 may host a financial service provider website that a user device may access by providing an attempted login that are authenticated by the fraud monitoring system 320. According to some embodiments, web server 408 may include software tools, similar to those described with respect to user device 402 above, that may allow web server 408 to obtain network identification data from user device 402. The web server may also be hosted by an online provider of website hosting, networking, cloud, or backup services, such as Microsoft Azure™ or Amazon Web Services™

The local network 410 may include any type of computer networking arrangement used to exchange data in a localized area, such as WiFi, Bluetooth™, Ethernet, and other suitable network connections that enable components of the temporary card generation system 404 to interact with one another and to connect to the network 406 for interacting with components in the system 400 environment. In some embodiments, the local network 410 may include an interface for communicating with or linking to the network 406. In other embodiments, certain components of the temporary card generation system 404 may communicate via the network 406, without a separate local network 410.

The temporary card generation system 404 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 402 may be able to access temporary card generation system 404 using the cloud computing environment. User device 402 may be able to access temporary card generation system 404 using specialized software. The cloud computing environment may eliminate the need to install specialized software on user device 402.

In accordance with certain example implementations of the disclosed technology, the temporary card generation system 404 may include one or more computer systems configured to compile data from a plurality of sources, such as the fraud monitoring system 320, web server 408, and/or the database 412. The fraud monitoring system 320 may correlate compiled data, analyze the compiled data, arrange the compiled data, generate derived data based on the compiled data, and store the compiled and derived data in a database such as the database 412. According to some embodiments, the database 412 may be a database associated with an organization and/or a related entity that stores a variety of information relating to customers, transactions, ATM, and business operations. The database 412 may also serve as a back-up storage device and may contain data and information that is also stored on, for example, database 360, as discussed with reference to FIG. 3.

Embodiments consistent with the present disclosure may include datasets. Datasets may comprise actual data reflecting real-world conditions, events, and/or measurements. However, in some embodiments, disclosed systems and methods may fully or partially involve synthetic data (e.g., anonymized actual data or fake data). Datasets may involve numeric data, text data, and/or image data. For example, datasets may include transaction data, financial data, demographic data, public data, government data, environmental data, traffic data, network data, transcripts of video data, genomic data, proteomic data, and/or other data. Datasets of the embodiments may be in a variety of data formats including, but not limited to, PARQUET, AVRO, SQLITE, POSTGRESQL, MYSQL, ORACLE, HADOOP, CSV, JSON, PDF, JPG, BMP, and/or other data formats.

Datasets of disclosed embodiments may have a respective data schema (e.g., structure), including a data type, key-value pair, label, metadata, field, relationship, view, index, package, procedure, function, trigger, sequence, synonym, link, directory, queue, or the like. Datasets of the embodiments may contain foreign keys, for example, data elements that appear in multiple datasets and may be used to cross-reference data and determine relationships between datasets. Foreign keys may be unique (e.g., a personal identifier) or shared (e.g., a postal code). Datasets of the embodiments may be “clustered,” for example, a group of datasets may share common features, such as overlapping data, shared statistical properties, or the like. Clustered datasets may share hierarchical relationships (e.g., data lineage).

### Example Use Case

The following example use case describes examples of a typical user flow pattern. This section is intended solely for explanatory purposes and not in limitation.

In one example, a customer of a financial institution may approach an affiliated ATM. The customer may have recently lost his mobile device and/or ATM card-either of which might ordinarily allow the customer to fully authenticate himself for conducting a variety of transactions at the ATM, such as withdrawing cash. Without having the customer's mobile device or ATM card, however, the customer might still be able to semi-authenticate himself with the ATM by providing the ATM with other personally identifiable information, such as a phone number, social security number, etc. The customer might enter this personally identifiable information via the ATM's display screen. The backend system might then be able to at least semi-authenticate this customer. On the ATM screen, the customer might then be prompted to enter additional information (e.g., a date of birth, email address, username, etc.) and/or to select an account the customer wishes to access.

Once the customer selects the account, the system may be configured to generate a temporary card number and associate that temporary card number with the customer's selected account. The ATM might then dispense a physical payment card associated with the generated temporary card number.

The customer can then take that physical payment card to a merchant and attempt to conduct a transaction at the merchant's POS terminal (e.g., by swiping the payment card). Once the attempted transaction is received at the merchant POS, the merchant will transmit an authorization request to the card issuer (e.g., the financial institution) to authorize the transaction. Before authorizing the attempted transaction, however, the financial institution may utilize one or more MLMs to determine a likelihood of fraud associated with this particular attempted transaction. The MLMs utilized may be trained on a finite grouping of training data, e.g., only that data associated with other attempted transactions each associated with a similarly generated pre-authenticated temporary transaction card. Based on this specific training, the MLMs may be configured to determine the likelihood of fraud, such that the system can compare the determined likelihood to a threshold. This threshold may be a dynamic threshold, e.g., one that continuously changes based on the amount of training the MLMs have had, the number of other similar transactions used for training the MLMs, etc. If the system determines the likelihood of fraud does not exceed the threshold, the system may approve the attempted transaction. Otherwise, the system may conduct one or more fraud prevention actions, such as transmitting an alert to the customer (e.g., via a secondary device, email, etc.), locking the customer's account, etc.

In some examples, disclosed systems or methods may involve one or more of the following clauses:

Clause 1: A system comprising: one or more processors; and a memory in communication with the one or more processors and storing instructions that, when executed by the one or more processors, are configured to cause the system to: receive, via an automated teller machine (ATM), personally identifiable information associated with a first user; responsive to receiving the personally identifiable information, authenticate the first user; responsive to authenticating the first user, generate a temporary account number; associate the temporary account number with a primary account associated with the first user; dispense, via the ATM, a physical payment card associated with the temporary account number; receive, via a merchant point of sale (POS) terminal, an attempted transaction associated with the physical payment card; identify a plurality of previously generated physical payment cards each associated with a respective temporary account number generated responsive to authenticating a respective associated user; determine, using one or more machine learning models (MLMs), a likelihood of fraud associated with the attempted transaction, wherein the one or more MLMs are trained based on one or more attempted transactions associated with the identified plurality of previously generated physical payment cards; determine whether the likelihood of fraud exceeds a threshold; and responsive to determining the likelihood of fraud does not exceed the threshold, approve the attempted transaction.

Clause 2: The system of clause 1, wherein the personally identifiable information comprises a phone number, a social security number, an account number, or combinations thereof.

Clause 3: The system of clause 1, wherein the instructions are further configured to cause the system to: responsive to receiving the personally identifiable information: transmit a request for the first user to provide additional authentication information; and receive, via the ATM, the additional authentication information, wherein generating the temporary account number is further responsive to receiving the additional authentication information.

Clause 4: The system of clause 3, wherein the additional authentication information comprises a biometric input, a code, a personal identification number (PIN), an answer to a security question, or combinations thereof.

Clause 5: The system of clause 1, wherein the instructions are further configured to cause the system to: responsive to determining the likelihood of fraud exceeds the threshold, conduct one or more fraud prevention actions.

Clause 6: The system of clause 1, wherein: the one or more MLMs comprise a first MLM and a second MLM, the first MLM is associated with a first weighting factor, the second MLM is associated with a second weighting factor, and determining the likelihood of fraud is based on the first and second weighting factors.

Clause 7: The system of clause 6, wherein: the first MLM is trained to determine the likelihood of fraud associated with the attempted transaction based on historical transaction data, and the second MLM is trained to determine the likelihood of fraud associated with the attempted transaction based on the one or more attempted transactions associated with the identified plurality of previously generated physical payment cards.

Clause 8: The system of clause 7, wherein the second weighting factor is higher than the first weighting factor.

Clause 9: A system comprising: one or more processors; and a memory in communication with the one or more processors and storing instructions that, when executed by the one or more processors, are configured to cause the system to: receive, via one or more automated teller machines (ATMs), respective personally identifiable information associated with a plurality of users; responsive to receiving the respective personally identifiable information, authenticate the plurality of users; responsive to authenticating the plurality of users, generate a respective temporary account number associated with each of the plurality of users; associate the respective temporary account number with a respective primary account associated with each of the plurality of users; dispense, via the one or more ATMs, a respective physical payment card associated with each of the respective temporary account numbers; receive, via a merchant point of sale (POS) terminal, an attempted transaction associated with a first physical payment card; determine, using one or more machine learning models (MLMs), a likelihood of fraud associated with the attempted transaction, wherein the one or more MLMs are trained based on one or more attempted transactions associated with the respective physical payment card associated with each of the respective temporary account numbers; determine whether the likelihood of fraud exceeds a threshold; and responsive to determining the likelihood of fraud does not exceed the threshold, approve the attempted transaction.

Clause 10: The system of clause 9, wherein the respective personally identifiable information comprises a phone number, a social security number, an account number, or combinations thereof.

Clause 11: The system of clause 9, wherein the instructions are further configured to cause the system to: responsive to receiving the respective personally identifiable information: transmit a request for the plurality of users to provide additional authentication information; and receive, via the one or more ATMs, the additional authentication information, wherein generating the respective temporary account number is further responsive to receiving the additional authentication information.

Clause 12: The system of clause 11, wherein the additional authentication information comprises a biometric input, a code, a personal identification number (PIN), an answer to a security question, or combinations thereof.

Clause 13: The system of clause 9, wherein the respective temporary account number comprises a virtual card number.

Clause 14: The system of clause 9, wherein: the one or more MLMs comprise a first MLM and a second MLM, the first MLM is associated with a first weighting factor, the second MLM is associated with a second weighting factor, and determining the likelihood of fraud is based on the first and second weighting factors.

Clause 15: The system of clause 14, wherein: the first MLM is trained to determine the likelihood of fraud associated with the attempted transaction based on historical transaction data, and the second MLM is trained to determine the likelihood of fraud associated with the attempted transaction based on the one or more attempted transactions associated with the respective physical payment card associated with each of the respective temporary account numbers.

Clause 16: The system of clause 15, wherein the second weighting factor is higher than the first weighting factor.

Clause 17: A system comprising: one or more processors; and a memory in communication with the one or more processors and storing instructions that, when executed by the one or more processors, are configured to cause the system to: receive, via one or more automated teller machines (ATMs), personally identifiable information associated with a plurality of users; authenticate the plurality of users based on the personally identifiable information; generate a respective temporary account number associated with each of the plurality of users; dispense, via the one or more ATMs, a respective payment card associated with each of the respective temporary account numbers; receive, via a merchant point of sale (POS) terminal, an attempted transaction associated with a first payment card; determine, using one or more machine learning models (MLMs), a likelihood of fraud associated with the attempted transaction, wherein the one or more MLMs are trained based on one or more attempted transactions associated with the respective payment card associated with each of the respective temporary account numbers; determine whether the likelihood of fraud exceeds a threshold; and responsive to determining the likelihood of fraud does not exceed the threshold, approve the attempted transaction.

Clause 18: The system of clause 7, wherein: the one or more MLMs comprise a first MLM and a second MLM, the first MLM is associated with a first weighting factor, the second MLM is associated with a second weighting factor, and determining the likelihood of fraud is based on the first and second weighting factors.

Clause 19: The system of clause 18, wherein: the first MLM is trained to determine the likelihood of fraud associated with the attempted transaction based on historical transaction data, and the second MLM is trained to determine the likelihood of fraud associated with the attempted transaction based on the one or more attempted transactions associated with the respective payment card associated with each of the respective temporary account numbers.

Clause 20: The system of clause 19, wherein the second weighting factor is higher than the first weighting factor.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
one or more processors; and
a memory in communication with the one or more processors and storing instructions that, when executed by the one or more processors, are configured to cause the system to:
receive, via an automated teller machine (ATM), personally identifiable information associated with a first user;
responsive to receiving the personally identifiable information, authenticate the first user;
responsive to authenticating the first user, generate a temporary account number;
associate the temporary account number with a primary account associated with the first user;
dispense, via the ATM, a physical payment card associated with the temporary account number;
receive, via a merchant point of sale (POS) terminal, an attempted transaction associated with the physical payment card;
identify a plurality of previously generated physical payment cards each associated with a respective temporary account number generated responsive to authenticating a respective associated user;
determine, using one or more machine learning models (MLMs), a likelihood of fraud associated with the attempted transaction, wherein the one or more MLMs are trained based on one or more attempted transactions associated with the identified plurality of previously generated physical payment cards;
determine whether the likelihood of fraud exceeds a threshold; and
responsive to determining the likelihood of fraud does not exceed the threshold, approve the attempted transaction.

2. The system of claim 1, wherein the personally identifiable information comprises a phone number, a social security number, an account number, or combinations thereof.

3. The system of claim 1, wherein the instructions are further configured to cause the system to:
responsive to receiving the personally identifiable information:
transmit a request for the first user to provide additional authentication information; and
receive, via the ATM, the additional authentication information,
wherein generating the temporary account number is further responsive to receiving the additional authentication information.

4. The system of claim 3, wherein the additional authentication information comprises a biometric input, a code, a personal identification number (PIN), an answer to a security question, or combinations thereof.

5. The system of claim 1, wherein the instructions are further configured to cause the system to:
responsive to determining the likelihood of fraud exceeds the threshold, conduct one or more fraud prevention actions.

6. The system of claim 1, wherein:
the one or more MLMs comprise a first MLM and a second MLM,
the first MLM is associated with a first weighting factor,
the second MLM is associated with a second weighting factor, and
determining the likelihood of fraud is based on the first and second weighting factors.

7. The system of claim 6, wherein:
the first MLM is trained to determine the likelihood of fraud associated with the attempted transaction based on historical transaction data, and
the second MLM is trained to determine the likelihood of fraud associated with the attempted transaction based on the one or more attempted transactions associated with the identified plurality of previously generated physical payment cards.

8. The system of claim 7, wherein the second weighting factor is higher than the first weighting factor.

9. A system comprising:
one or more processors; and
a memory in communication with the one or more processors and storing instructions that, when executed by the one or more processors, are configured to cause the system to:
receive, via one or more automated teller machines (ATMs), respective personally identifiable information associated with a plurality of users;
responsive to receiving the respective personally identifiable information, authenticate the plurality of users;
responsive to authenticating the plurality of users, generate a respective temporary account number associated with each of the plurality of users;
associate the respective temporary account number with a respective primary account associated with each of the plurality of users;
dispense, via the one or more ATMs, a respective physical payment card associated with each of the respective temporary account numbers;
receive, via a merchant point of sale (POS) terminal, an attempted transaction associated with a first physical payment card;
determine, using one or more machine learning models (MLMs), a likelihood of fraud associated with the attempted transaction, wherein the one or more MLMs are trained based on one or more attempted transactions associated with the respective physical payment card associated with each of the respective temporary account numbers;
determine whether the likelihood of fraud exceeds a threshold; and
responsive to determining the likelihood of fraud does not exceed the threshold, approve the attempted transaction.

10. The system of claim 9, wherein the respective personally identifiable information comprises a phone number, a social security number, an account number, or combinations thereof.

11. The system of claim 9, wherein the instructions are further configured to cause the system to:
responsive to receiving the respective personally identifiable information:
transmit a request for the plurality of users to provide additional authentication information; and
receive, via the one or more ATMs, the additional authentication information,
wherein generating the respective temporary account number is further responsive to receiving the additional authentication information.

12. The system of claim 11, wherein the additional authentication information comprises a biometric input, a code, a personal identification number (PIN), an answer to a security question, or combinations thereof.

13. The system of claim 9, wherein the respective temporary account number comprises a virtual card number.

14. The system of claim 9, wherein:
the one or more MLMs comprise a first MLM and a second MLM,
the first MLM is associated with a first weighting factor,
the second MLM is associated with a second weighting factor, and
determining the likelihood of fraud is based on the first and second weighting factors.

15. The system of claim 14, wherein:
the first MLM is trained to determine the likelihood of fraud associated with the attempted transaction based on historical transaction data, and
the second MLM is trained to determine the likelihood of fraud associated with the attempted transaction based on the one or more attempted transactions associated with the respective physical payment card associated with each of the respective temporary account numbers.

16. The system of claim 15, wherein the second weighting factor is higher than the first weighting factor.

17. A system comprising:
one or more processors; and
a memory in communication with the one or more processors and storing instructions that, when executed by the one or more processors, are configured to cause the system to:
receive, via one or more automated teller machines (ATMs), personally identifiable information associated with a plurality of users;
authenticate the plurality of users based on the personally identifiable information;
generate a respective temporary account number associated with each of the plurality of users;
dispense, via the one or more ATMs, a respective payment card associated with each of the respective temporary account numbers;
receive, via a merchant point of sale (POS) terminal, an attempted transaction associated with a first payment card;
determine, using one or more machine learning models (MLMs), a likelihood of fraud associated with the attempted transaction, wherein the one or more MLMs are trained based on one or more attempted transactions associated with the respective payment card associated with each of the respective temporary account numbers;
determine whether the likelihood of fraud exceeds a threshold; and
responsive to determining the likelihood of fraud does not exceed the threshold, approve the attempted transaction.

18. The system of claim 7, wherein:
the one or more MLMs comprise a first MLM and a second MLM,
the first MLM is associated with a first weighting factor,
the second MLM is associated with a second weighting factor, and
determining the likelihood of fraud is based on the first and second weighting factors.

19. The system of claim 18, wherein:
the first MLM is trained to determine the likelihood of fraud associated with the attempted transaction based on historical transaction data, and
the second MLM is trained to determine the likelihood of fraud associated with the attempted transaction based on the one or more attempted transactions associated with the respective payment card associated with each of the respective temporary account numbers.

20. The system of claim 19, wherein the second weighting factor is higher than the first weighting factor.
